(19) United States
(12) Patent Application Publication
(10) Pub. No.: US 2015/0151984 A1
(43) Pub. Date: Jun. 4, 2015

(54) SEPARATION MEMBRANE, METHOD OF MANUFACTURING THE SAME, AND WATER TREATMENT DEVICE INCLUDING THE SEPARATION MEMBRANE

(71) Applicant: Samsung Electronics Co., Ltd., Suwon-Si (KR)

(72) Inventors: Jung Im HAN, Yongin-si (KR); Sung Soo HAN, Hwaseong-si (KR); Ho Bum PARK, Seoul (KR); Young Hoon CHO, Seoul (KR)

(73) Assignee: IUCF-HYU (Industry-University Cooperation Foundation Hanyang University), Seoul (KR)

(21) Appl. No.: 14/557,955

(22) Filed: Dec. 2, 2014

(30) Foreign Application Priority Data
Dec. 3, 2013 (KR) 10-2013-0149209

(51) Int. Cl. C02F 1/44; B01D 71/68; B01D 67/00

(52) U.S. Cl. CPC C02F 1/445; B01D 67/0079; B01D 71/68; B01D 2323/40

(57) ABSTRACT

An organic/inorganic hybrid membrane may include a plurality of inorganic nanoparticles dispersed in an organic polymer matrix. The surface of the inorganic nanoparticles may be coated with a silane compound including a cationic functional group selected from an ammonium group (—NH₃⁺), a phosphonium group (—PR₄⁺), or a sulfonium group (—SR₃⁺). The organic polymer matrix may include an anionic functional group. The organic/inorganic hybrid membrane may be manufactured by a non-solvent induced phase-separation method. A separation membrane may include the organic/inorganic hybrid membrane. A water treatment device may include the separation membrane.

### CROSS-REFERENCE TO RELATED APPLICATION

This application claims priority under 35 U.S.C. §119 to Korean Patent Application No. 10-2013-0149209, filed in the Korean Intellectual Property Office on Dec. 3, 2013, the entire contents of which are incorporated herein by reference.

### BACKGROUND

1. Field

The present disclosure relates to a separation membrane, a method of manufacturing the same, and a water treatment device including the same.

2. Description of the Related Art

There has been a growing interest in forward osmosis (FO) technology with an increasing demand for development of a separation membrane having high efficiency but low energy consumption. Forward osmosis, like reverse osmosis, requires a semi-permeable membrane that is capable of filtering an osmotic pressure-drawing solute. However, forward osmosis uses a concentration difference instead of a pressure difference in order to separate materials, unlike reverse osmosis. Thus, a forward osmosis process may be operated under a very low pressure or even without any pressure.

On the contrary, a reverse osmosis process is operated by using a separation membrane for filtering salts or foreign particles which is laminated on a support layer that can endure a high pressure, since water is separated with pressure. However, since the forward osmosis process separates water using water diffusion according to an osmotic pressure rather than by directly applying pressure, a support layer may have hydrophilicity as well as porosity or tortuosity, thickness, and the like, in addition to mechanical strength, so that the support layer may help with the water diffusion. Recently, a more hydrophilic, thinner, and more porous support layer has been reported to improve permeation flux of a separation membrane.

### SUMMARY

Some embodiments relate to an organic/inorganic hybrid membrane having improved hydrophilicity and mechanical strength.

Some embodiments relate to a method of manufacturing the organic/inorganic hybrid membrane.

Some embodiments relate to a separation membrane including the organic/inorganic hybrid membrane.

Some embodiments relate to a method of manufacturing the separation membrane.

Some embodiments relate to a water treatment device including the separation membrane.

One example embodiment relates to an organic/inorganic hybrid membrane including a plurality of inorganic nanoparticles dispersed in an organic polymer matrix, wherein the surface of the inorganic nanoparticles are coated with a silane compound including a cationic functional group selected from an ammonium group (—NH₃⁺), a phosphonium group (—PR₄⁺), or a sulfonium group (—SR₃⁺), the organic polymer matrix includes an anionic functional group. The organic/inorganic hybrid membrane is manufactured by a non-solvent induced phase-separation method.

The organic polymer matrix may include an aryl backbone polymer such as polysulfone, polyethersulfone, polyphenylsulfone, polyetherethersulfone, polyetherketone, polyetheretherketone, polyphenylene ether, polydiphenylphenylene ether, or polyphenylene sulfide, or a cellulose-based polymer such as cellulose acetate, cellulose diacetate, or cellulose triacetate.

The inorganic nanoparticle may include an oxide nanoparticle or hydroxide nanoparticle of Ti, Al, Zr, Si, Sn, B, or Ce.

The anionic functional group may be selected from a carboxyl group (—COOH), a sulfonic acid group (—SO₃H), a phosphinic group (—PO₃H₂), a phosphonic group (—HPO₃H), a nitrous acid group (—NO₂H), and a combination thereof.

The inorganic nanoparticles and the organic polymer matrix in the membrane may be bonded with each other by an electrostatic attractive force between the cationic functional group and the anionic functional group.

The organic polymer matrix may include polysulfone or polyethersulfone.

The inorganic nanoparticles may be silica nanoparticles.

The anionic functional group may be a carboxyl group.

The material having the cationic functional group may be a silane compound represented by the following Chemical Formula 1 including an ammonium group at the terminal end.

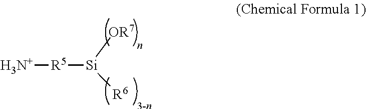

In the above Chemical Formula 1, R⁵ is a C1 to C20 alkylene, a C2 to C20 alkenylene, a C2 to C20 alkynylene, a C3 to C20 cycloalkylene, or a C6 to C18 arylene. R⁶ and R⁷ are the same or different, and are each independently hydrogen, a C1 to C20 alkyl, a C2 to C20 alkenyl, a C2 to C20 alkynyl, a C3 to C20 cycloalkyl, or a C6 to C18 aryl, and n is an integer ranging from 1 to 3.

An average particle size of the plurality of inorganic nanoparticles in the membrane may be less than or equal to about 100 nm, for example less than or equal to about 70 nm, or about 20 nm to about 30 nm.

A content of the plurality of inorganic nanoparticles in the membrane may be about 1% to about 30%, for example about 2% to about 20%, and for another example about 2.5% to about 20%, based on the weight of the organic polymer material.

Another example embodiment relates to a method of manufacturing an organic/inorganic hybrid membrane. The method of manufacturing may include preparing a plurality of inorganic nanoparticles that are surface-coated with a silane compound having a cationic functional group selected from an ammonium group (—NH₃⁺), a phosphonium group (—PR₄⁺), and a sulfonium group (—SR₃⁺); introducing the surface-coated inorganic nanoparticles into a solution of an organic polymer material including an anionic functional group to prepare a mixed solution; and applying a non-solvent induced phase-separation method after casting the mixed solution on a substrate, wherein the organic/inorganic hybrid membrane includes the plurality of hydrophilic inorganic nanoparticles dispersed in an organic polymer matrix.

The process of preparing the plurality of inorganic nanoparticles surface-coated with the silane compound including the cationic functional group may include contacting silica nanoparticles with the compound of the above Chemical Formula 1 to coat the surface of the silica nanoparticles with the compound of the above Chemical Formula 1.

Another example embodiment relates to a separation membrane for water treatment including the organic/inorganic hybrid membrane.

The separation membrane may further include a separation layer for filtering a foreign particle on one surface of the organic/inorganic hybrid membrane.

The separation layer may include an additional polymer matrix, as a semi-permeable membrane that is water permeable but non-permeable for a subject material to be separated.

The polymer matrix for forming the separation layer may include an aryl backbone polymer. Examples of acceptable materials include polyamide, polyethylene, polyester, polyisobutylene, polytetrafluoroethylene, polypropylene, polyacrylonitrile, polysulfone, polyethersulfone, polycarbonate, polyethylene terephthalate, polyimide, polyvinylene fluoride, polyvinylchloride, polyphenylene sulfide, cellulose acetate, cellulose diacetate, or cellulose triacetate.

Another example embodiment relates to a method of manufacturing the separation membrane.

The method of manufacturing the separation membrane may include polymerizing a separation layer consisting of the polymer matrix through interface polymerization, on one surface of the organic/inorganic hybrid membrane.

Another example embodiment relates to a water treatment device including the separation membrane.

The water treatment device may be a forward osmosis water treatment device or a reverse osmosis water treatment device.

### BRIEF DESCRIPTION OF THE DRAWINGS

FIG. 1 is a schematic view showing a method of manufacturing a hybrid separation membrane that includes coating a silane compound having an ammonium group on the surface of a silica nanoparticle, adding the silica nanoparticle coated with the silane compound having an ammonium group to a solution including a polymer having an anionic functional group to prepare an organic/inorganic hybrid solution, casting the organic/inorganic hybrid solution to form an organic/inorganic hybrid membrane by using a non-solvent induced phase-separation method, and forming a polyamide layer on one surface of the organic/inorganic hybrid membrane according to an example embodiment.

FIG. 2 shows photographs illustrating the dissolubility of (a) the silica nanoparticle in water before being coated with the silane compound having an ammonium group, (b) the silica nanoparticle coated with the silane compound having an ammonium group in water, and (c) the silica nanoparticle coated with the silane compound having an ammonium group in a polar organic solvent.

FIG. 3 shows chemical structures of polysulfone (a) and carboxylated polysulfone (b).

FIG. 4 shows a reaction scheme of a process of carboxylating polysulfone by using a lithiation reaction.

FIG. 5 shows an electrostatic bond relationship between the silica nanoparticle coated with a silane compound having an ammonium group and a carboxylated polysulfone polymer according to an example embodiment.

FIG. 6 is a graph showing contact angle and zeta potential changes depending on a degree of carboxylation (degree of substitution) of the carboxylated polysulfone.

FIG. 7 is a scanning electron microscopy (SEM) photograph showing an organic/inorganic hybrid membrane obtained by dispersing SiO₂ nanoparticles coated with an amine compound into the carboxylated polysulfone according to Example 1 at 2.5% of the mass thereof.

FIG. 8 is a scanning electron microscopy (SEM) photograph showing an organic/inorganic hybrid membrane obtained by dispersing SiO₂ nanoparticles into polysulfone at 5% of the mass thereof.

FIG. 9 is a scanning electron microscopy (SEM) photograph showing an organic/inorganic hybrid membrane obtained by dispersing SiO₂ nanoparticles coated with a silane compound having an ammonium group into polysulfone at 2.5% of the mass thereof.

FIG. 10 is an enlarged photograph of a part of FIG. 9.

FIG. 11 is a graph showing forward osmosis water flux and salt rejection of a separation membrane including a polyamide separation layer on a polysulfone support layer, and sequentially from left to right, shows results of a separation membrane using a polysulfone support layer including no inorganic nanoparticles (Control Group 1), a separation membrane using a support layer formed by dispersing SiO₂ nanoparticles coated with a silane compound having an ammonium group into polysulfone at 2.5% of the mass thereof (Comparative Example 2), a separation membrane using carboxylated polysulfone as a support layer but including no inorganic nanoparticles (Control Group 2), and a separation membrane using a polysulfone support layer formed by dispersing SiO₂ nanoparticles coated with a silane compound having an ammonium group into carboxylated polysulfone at 2.5% of the mass thereof (Example 1).

FIG. 12 is a schematic view showing a forward osmosis water treatment device according to one example embodiment.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

One example embodiment relates to an organic/inorganic hybrid membrane including a plurality of inorganic nanoparticles dispersed in an organic polymer matrix. The surface of the plurality of inorganic nanoparticles are coated with a silane compound including a cationic functional group selected from an ammonium group (—NH₃⁺), a phosphonium group (—PR₄⁺), or a sulfonium group (—SR₃⁺). The organic polymer matrix includes an anionic functional group. The organic/inorganic hybrid membrane is manufactured by a non-solvent induced phase-separation method.

The “non-solvent induced phase-separation method (NIPS)” using a phase change of a polymer solution is known as a commercially available method of manufacturing a porous support layer used in a separation membrane for water treatment. The “non-solvent induced phase-separation method” is a method of forming a polymer matrix by a phase change of a polymer solution by mixing a polymer with a polar organic solvent to prepare the polymer solution, coating the polymer solution on a substrate, and dipping the coated substrate in water.

On the other hand, a method of combining an organic polymer with an inorganic nanoparticle has been conventionally considered to increase hydrophilicity and mechanical strength of a membrane. Herein, the conventional method of manufacturing an organic/inorganic hybrid membrane is performed by dispersing a plurality of inorganic particles into a polymer solution, casting the mixed solution of the polymer and the inorganic particles on a substrate, and then applying the “non-solvent induced phase-separation method (NIPS)” thereto. However, hydrophilic nanoparticles in general are not uniformly dispersed in a polymer solution and are aggregated with one another, and even though partly dispersed, they are mostly dispersed toward water during phase transition of a polymer when a non-solvent induced phase-separation method is applied thereto and thus few remain in a polymer membrane. The loss of the nanoparticles may be compensated by increasing the amount of the nanoparticles, but this may produce a defect in the membrane. Accordingly, the organic/inorganic hybrid membrane may not show a sufficient hydrophilic effect.

Accordingly, technology of uniformly dispersing hydrophilic nanoparticles into a polymer solution and minimizing the loss of the hydrophilic nanoparticles in a polymer membrane during phase transition is required.

Since the surface of inorganic nanoparticles is coated with a material having a cationic functional group, and an organic polymer forming an organic polymer matrix includes an anionic functional group, an electrostatic attractive force is generated between the inorganic nanoparticles and the organic polymer when the inorganic nanoparticles are added to a solution including the organic polymer and may uniformly disperse the inorganic nanoparticles into the organic polymer solution without cohesion. In addition, when an organic/inorganic hybrid membrane is manufactured by casting the inorganic nanoparticles and an organic polymer solution on a substrate and applying a non-solvent induced phase-separation method thereto, the inorganic nanoparticles are bonded with the organic polymer by an electrostatic attractive force and thus may not be dispersed in water of a non-solvent but remain present in a large amount in the organic polymer matrix.

Accordingly, when the organic polymer material includes an anionic functional group and the inorganic nanoparticles are coated with a material having a cationic functional group, the organic polymer and the inorganic nanoparticles are respectively negatively and positively charged and bonded together by an electrostatic attractive force generated between the negatively and positively-charged materials. Accordingly, the inorganic nanoparticles are added in the organic solvent including an organic polymer, the inorganic nanoparticles are not aggregated but are uniformly dispersed in a solvent including the organic polymer.

In addition, when a non-solvent induced phase-separation method is applied after a mixed solution of the organic polymer and the inorganic nanoparticles is coated on a substrate to manufacture a membrane, the anionic functional group in the organic polymer is bonded with the cationic functional group coated in the inorganic nanoparticles by a stronger electrostatic attractive force by contacting the mixed solution of the organic polymer and the inorganic nanoparticles with water as a non-solvent. Accordingly, when the non-solvent induced phase-separation method is applied to the organic polymer and the inorganic nanoparticles, the inorganic nanoparticles may be suppressed from dispersion into the water as a non-solvent. In other words, since the inorganic nanoparticles coated with a material having a cationic functional group are at most dispersed into an organic polymer matrix obtained in a non-solvent induced phase-separation method and are suppressed from being discharged into the water during manufacture of the membrane, the amount of the inorganic nanoparticles included in the organic polymer matrix is increased, providing an organic/inorganic hybrid membrane having further increased hydrophilicity and mechanical strength.

The inorganic nanoparticle may be an oxide nanoparticle or hydroxide nanoparticle of Ti, Al, Zr, Si, Sn, B, or Ce, but is not limited thereto.

In an example embodiment, silica (SiO₂) may be used as an inorganic nanoparticle.

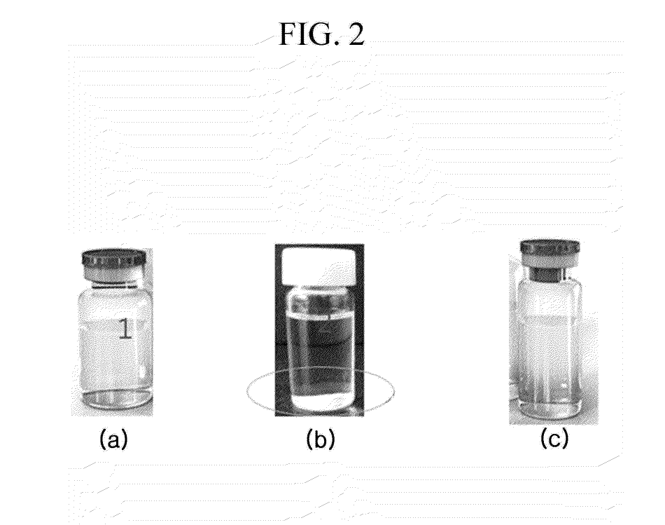

As shown in FIG. 2 (a), the silica is a hydrophilic inorganic nanoparticle and is negatively charged on the surface, and thus tends to be well dispersed in water. When the hydrophilic nanoparticles are added to an organic polymer solution to manufacture an organic/inorganic hybrid membrane, the hydrophilic nanoparticles are not well dispersed in the organic polymer solution but are aggregated, and may also be mostly dispersed in water during a non-solvent induced phase-separation process and not highly included in the membrane.

According to an example embodiment, the surface of the silica nanoparticle may be coated with a silane compound having an ammonium group, 3-ammoniumpropyl methoxysilane (APS), as a surface ligand having a cationic functional group. Accordingly, negative charges on the surface of the silica nanoparticle may be adjusted to decrease hydrophilicity of the silica nanoparticle but increase dispersity of the silica nanoparticle into a solvent including an organic polymer.

The coating of the material having a cationic functional group on the surface of the silica (SiO₂) may include contacting the silica nanoparticles with the material having a cationic functional group. The silica nanoparticles coated with the material having a cationic functional group have sharply decreased surface charges and are aggregated in the water unlike the silica nanoparticles before the surface treatment (refer to FIG. 2(b)). Herein, the silica nanoparticles have no dispersion in water but have dispersion in an organic solvent, and thus are not aggregated but are well mixed due to improved miscibility when mixed with an organic polymer solution as shown in FIG. 2 (c).

The material having a cationic functional group for surface-treating inorganic nanoparticles such as silica and the like may be a material including an ammonium group (—NH₃⁺), a phosphonium group (—PR₄⁺), or a sulfonium group (—SR₃⁺), but is not limited thereto.

An organic polymer material used to manufacture an organic/inorganic hybrid membrane may include any organic polymer used to manufacture a support of a separation membrane for water treatment. For example, the organic polymer material may be selected from an aryl backbone polymer such as polysulfone, polyethersulfone, polyphenylsulfone, polyetherethersulfone, polyetherketone, polyetheretherketone, polyphenylene ether, polydiphenylphenylene ether, or polyphenylene sulfide, or a cellulose-based polymer such as cellulose acetate, cellulose diacetate, or cellulose triacetate, but is not limited thereto.

An anionic functional group included in the organic polymer material and generating an electrostatic attractive force with a positively-charged material coated on the surface of the inorganic nanoparticles may include a carboxyl group (—COOH), a sulfonic acid group (—SO₃H), a phosphinic group (—PO₃H₂), a phosphonic group (—HPO₃H), a nitrous acid group (—NO₂H), or the like, but are not limited thereto.

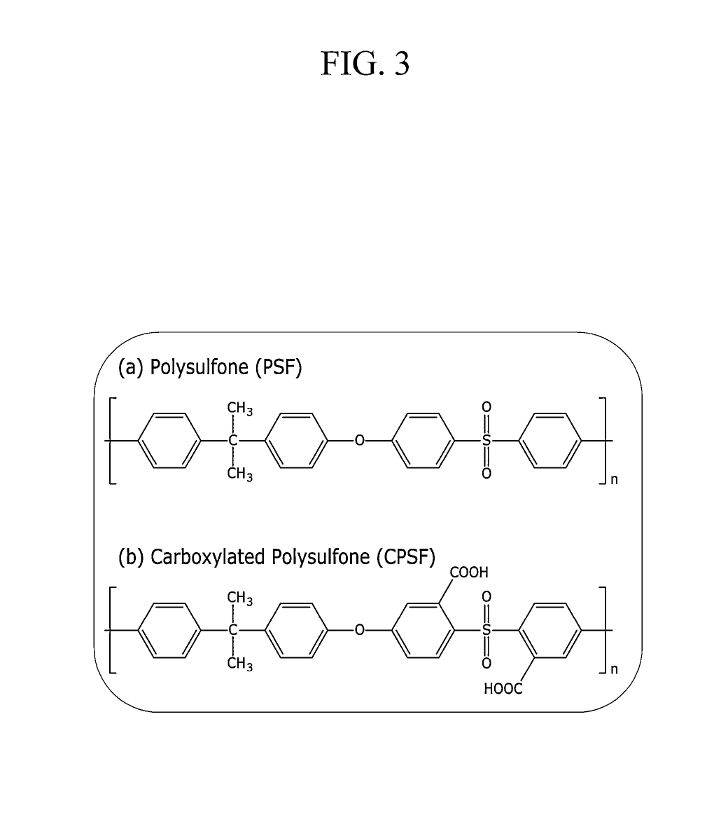

In an example embodiment, the organic polymer matrix may use polysulfone or polyether sulfone. The chemical structures of the polysulfone having no anionic functional group (FIG. 3 (a)) and the carboxylated polysulfone obtained by introducing a carboxyl group as the anionic functional group into the polysulfone (FIG. 3 (b)) are provided in FIG. 3.

As shown from FIG. 3 (b), the carboxyl group as the anionic functional group may be substituted in an aromatic ring at a main chain of the polysulfone.

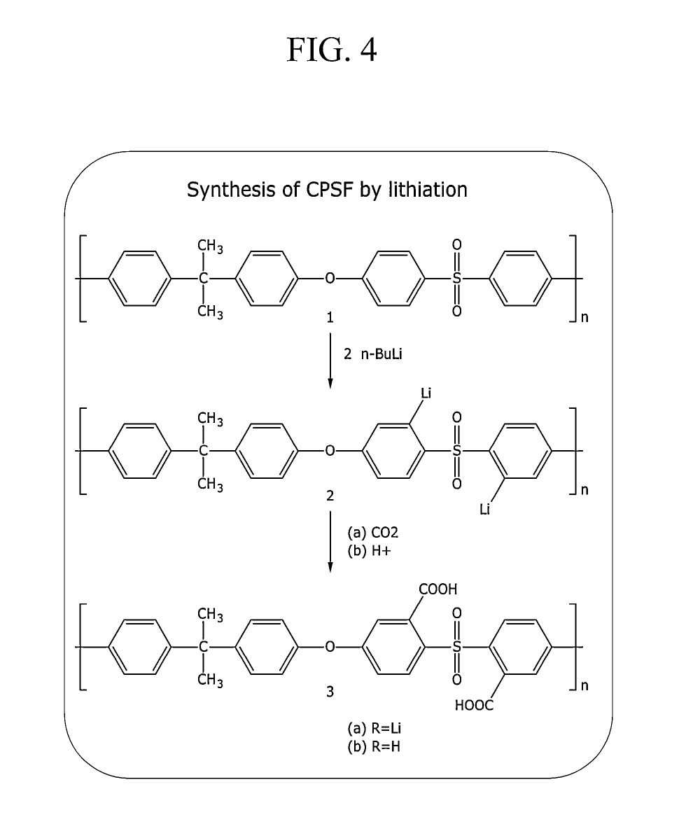

FIG. 4 shows a reaction scheme schematically illustrating a process of introducing the carboxyl group as the anionic functional group into the polysulfone according to an example embodiment. In other words, carboxylated polysulfone is obtained by adding butyllithium (BuLi) to the polysulfone to lithiate the aromatic ring at the main chain of the polysulfone, and then adding carbon dioxide (CO₂) and hydrogen gas thereto to substitute a carboxyl group at the position where lithium is substituted. This reaction is well known in a related art and will not be illustrated in detail. On the other hand, the kind of the organic polymer and the anionic functional group substituted therein may be appropriately selected depending on each purpose or use, and the selected anionic functional group may be appropriately substituted in the organic polymer by a person having ordinary skill by using a method known in the related art.

Accordingly, the present disclosure is not limited to substitution of a carboxyl group as an anionic functional group in polysulfone as the organic polymer.

The material having a cationic functional group coated on the surface of the hydrophilic inorganic particle may be a silane compound including an ammonium group at the terminal end.

The silane compound including an ammonium group at the terminal end may be represented by the following Chemical Formula 1.

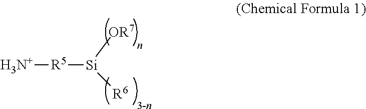

In the above Chemical Formula 1, R⁵ is a C1 to C20 alkylene, a C2 to C20 alkenylene, a C2 to C20 alkynylene, a C3 to C20 cycloalkylene, or a C6 to C18 arylene. R⁶ and R⁷ are the same or different, and are independently hydrogen, a C1 to C20 alkyl, a C2 to C20 alkenyl, a C2 to C20 alkynyl, a C3 to C20 cycloalkyl, or a C6 to C18 aryl, and n is an integer ranging from 1 to 3.

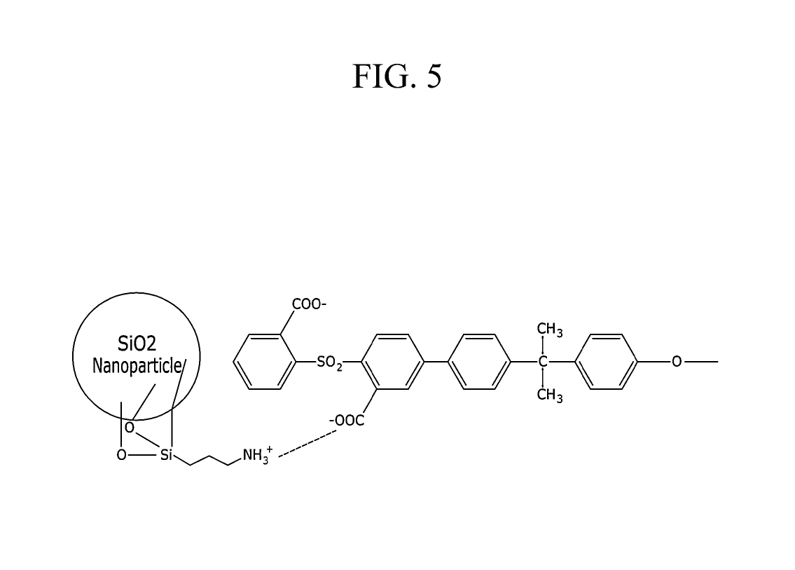

The silane compound is coated on the surface of silica, when silicon of the silane compound is bonded with oxygen generated on the silica by hydrolysis of a functional group marked as —OR⁷ bonded with a silicon element. The ammonium terminal end of the silane compound may be bonded with an anionic functional group substituted in the polymer through an electrostatic attractive force. FIG. 5 schematically shows a bond relationship between the surface-treated silica and the carboxylated polysulfone.

An average particle size of the inorganic nanoparticles in the membrane may be less than or equal to about 100 nm, for example less than or equal to about 70 nm, or about 20 nm to 30 nm.

The inorganic nanoparticles are not aggregated one another in the membrane, and may be present within a range of less than or equal to about tens of nanometers.

A content of the inorganic nanoparticles in the membrane may be about 1% to about 30%, for example about 2% to about 20%, based on the weight of the organic polymer material.

As aforementioned, since the inorganic nanoparticles are hardly lost in an organic/inorganic hybrid membrane, the inorganic nanoparticles can be included within the range in the organic/inorganic hybrid membrane.

The organic/inorganic membrane may have a thickness of about 20 μm to about 150 μm.

The membrane may be manufactured by using a non-solvent induced phase-separation method after casting a solution including the inorganic nanoparticles and the organic polymer material.

Accordingly, another example embodiment relates to a method of manufacturing an organic/inorganic hybrid membrane including preparing a plurality of inorganic nanoparticles that are surface-coated with a silane compound having a cationic functional group selected from an ammonium group (—NH₃⁺), a phosphonium group (—PR₄⁺), or a sulfonium group (—SR₃⁺); introducing the surface-coated inorganic nanoparticles into a solution of an organic polymer material including an anionic functional group to prepare a mixed solution; and applying a non-solvent induced phase-separation method after casting the mixed solution on a substrate, wherein the organic/inorganic hybrid membrane includes the plurality of hydrophilic inorganic nanoparticles dispersed in an organic polymer matrix.

As aforementioned, the preparation of inorganic nanoparticles coated with a material having a cationic functional group on the surface may include contacting the inorganic nanoparticles with the material having a cationic functional group, for example, a compound represented by the above Chemical Formula 1, or using commercially available inorganic nanoparticles coated with the compound represented by the above Chemical Formula 1 and the like.

Another example embodiment relates to a separation membrane for water treatment including the organic/inorganic hybrid membrane.

The separation membrane may further include a separation layer for filtering foreign particles on one surface of the organic/inorganic hybrid membrane.

The separation layer may include an additional polymer matrix, as a semi-permeable membrane that is water permeable but non-permeable for a subject material to be separated.

The polymer matrix for forming the separation layer may include an aryl backbone polymer. Examples of suitable materials include polyamide, polyethylene, polyester, polyisobutylene, polytetrafluoroethylene, polypropylene, polyacrylonitrile, polysulfone, polyethersulfone, polycarbonate, polyethylene terephthalate, polyimide, polyvinylene fluoride, polyvinylchloride and polyphenylene sulfide, cellulose acetate, cellulose diacetate, or cellulose triacetate.

Another example embodiment relates to a method of manufacturing the separation membrane.

The method of manufacturing the separation membrane may include polymerizing a separation layer consisting of a polymer matrix through interface polymerization, on one surface of the organic/inorganic hybrid membrane.

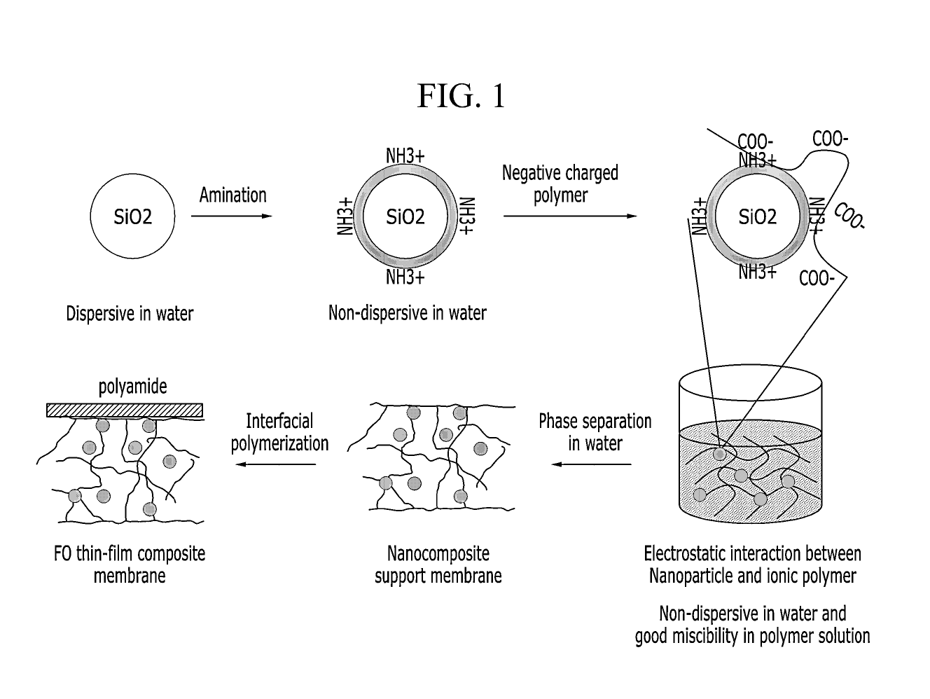

FIG. 1 is a schematic view showing a method of manufacturing the separation membrane.

Referring to FIG. 1, a hybrid separation membrane may be manufactured by contacting silica nanoparticles with a compound including an ammonium group in water to coat the amine-containing compound on the surface of the silica nanoparticles, dipping the coated nanoparticles in an organic polymer solution having an anion functional group to form an organic/inorganic hybrid membrane by a non-solvent induced phase-separation method according to an example embodiment, and forming a polyamide separation layer on the surface of the organic/inorganic hybrid membrane.

As aforementioned, the separation membrane may be formed by interface-polymerizing a monomer for a polyamide on the surface of the organic/inorganic membrane. This interface polymerization is well known in a related art and will not be illustrated in detail.

Another example embodiment relates to a water treatment device including the separation membrane.

The water treatment device may be a forward osmosis water treatment device or a reverse osmosis water treatment device, and for example, the separation membrane may be used for the forward osmosis water treatment device.

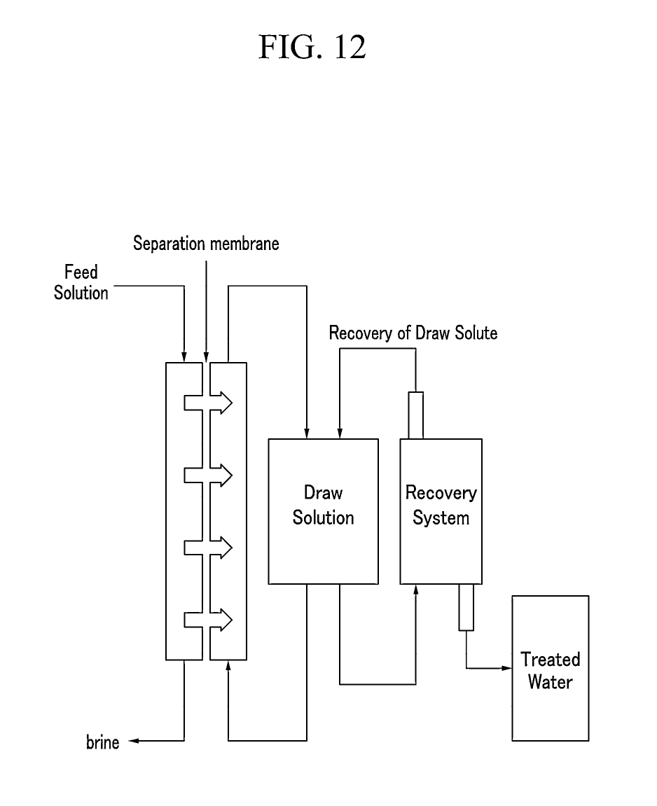

FIG. 12 shows a forward osmosis water treatment device according to an example embodiment.

A forward osmosis water treatment device according to one example embodiment includes a first housing including a receiving part for a feed solution including a subject material to be separated, a receiving part for an osmosis draw solution having a higher osmotic pressure concentration than the feed solution, and a separation membrane disposed between the receiving part for a feed solution and the receiving part for an osmosis draw solution; a second housing for storing the osmosis draw solution in order to supply the osmosis draw solution to the first housing and to recover the osmosis draw solution from the housing; and a recovery unit for separating and recovering a solute of the osmosis draw solution, wherein the separation membrane includes an organic/inorganic hybrid membrane including an inorganic nanoparticle coated with a material having a cationic functional group at the surface, which is dispersed in an organic polymer matrix including an anionic functional group, as a support layer, and further includes a separation layer of an interface polymerized polymer matrix on one surface of the organic/inorganic hybrid membrane.

The forward osmosis water treatment device may further include a device discharging the resultant as treated water after separating the osmosis draw solute from the osmosis draw solution including water passing the separation membrane from the feed solution due to osmotic pressure through the recovery unit.

The forward osmosis water treatment device may have the same organic/inorganic hybrid membrane and separation layer as the separation membrane as described above, and thus will not be described in detail.

The feed solution may include sea water, brackish water, wastewater, tap water to be treated for drinking, and the like.

The water treatment device may be applied for water purification, wastewater treatment and reuse, seawater desalination, and the like.

The forward osmosis water treatment device adopts a separation membrane including an organic/inorganic hybrid membrane having increased hydrophilicity and mechanical strength, and thus may accomplish much improved water permeability and higher energy efficiency.

Hereinafter, various embodiments are discussed in more detail. However, it should be understood that the following are merely examples and the present disclosure is not limited thereto.

### EXAMPLE

### Synthesis Example 1

### Manufacture of Carboxylated Polysulfone

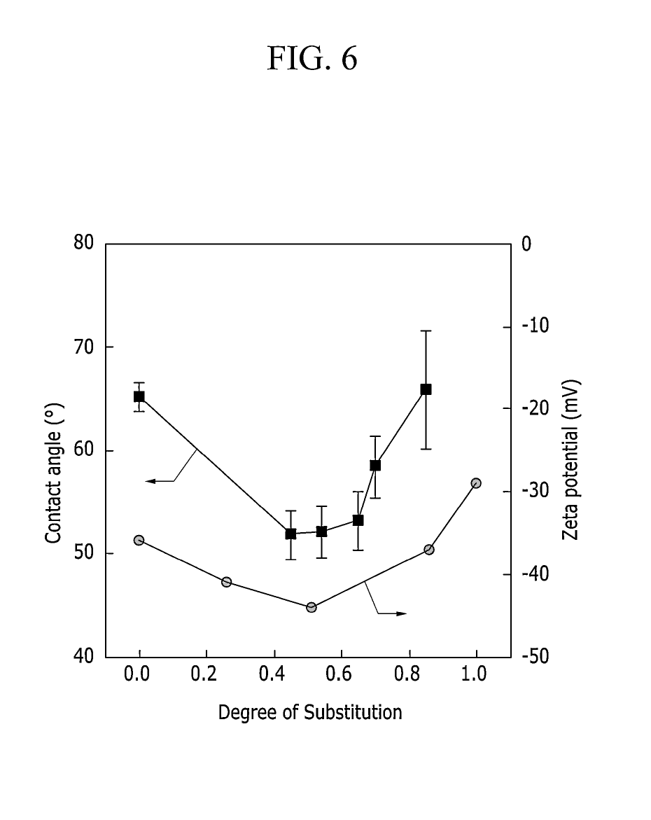

220 g of polysulfone having a molecular weight of 70,000-80,000 g/mol (Udel P 3500 made by Solvay Chemicals, Inc.) is dissolved in 1900 ml of a DMF solvent under a condition of no water, butyllithium is added thereto in each substitution degree of 0, 0.25, 0.49, 0.9, and 1.0 based on the total moles of a repeating unit at the main chain of the polysulfone, and the mixture is agitated to perform a lithiation reaction. When the lithiation reaction is complete, and CO₂ gas is added to each solution at −50° C. at a speed of 30 ml/hr, a carboxylation reaction in which the lithium at the main chain of the polysulfone is substituted with a carboxyl group is performed. When the carboxylation reaction is complete, the carboxylated polysulfone is separated through ethanol precipitation and obtained with each substitution degree of 0, 0.25, 0.49, 0.9, and 1.0. The contact angle and zeta potential of the obtained polysulfone are measured, and the results are provided in a graph of FIG. 6. The contact angle is measured in a sessile drop method using water. The zeta potential is measured by using a SurPASS analyzer (Anton Paar GmbH, Austria) capable of measuring electrokinetic potential on the surface of a membrane.

As shown in FIG. 6, the polysulfone is most hydrophilic when a carboxyl group has a substitution degree of about 0.49. Accordingly, the carboxylated polysulfone (CPSF) including a carboxyl group having a substitution degree of about 0.49 is used as a polymer in the following examples.

### Synthesis Example 2

### Manufacture of Silica Coated with Silane Compound Having Ammonium Group

As for silica coated with a silane compound having an ammonium group, silica coated with a silane compound having a 3-ammoniumpropyl functional group and having a diameter of about 100 nm (Aldrich Co., Ltd.) is used.

On the other hand, zeta potential and dispersion are measured for the silica coated with a silane compound having an ammonium group and for the general silica. The dispersion is evaluated by examining a particle distribution size and a distribution chart with a particle size analyzer or with the naked eye. As shown in FIG. 2, when about 10 mg of the general silica or the silica coated with a silane compound including an ammonium group is respectively dispersed in about 0.5 ml of water as a solvent, the general silica not coated with a compound including an ammonium group is well dispersed in water and becomes transparent ((a) of FIG. 2), while the silica coated with a compound including an ammonium group is not dispersed but is aggregated due to a decreased charge on the surface, and thus forms a precipitate ((b) of FIG. 2). On the other hand, when the silica coated with a compound including an ammonium group is dispersed in a polar organic solvent including a polysulfone polymer in the following examples, the silica is transparently dispersed as shown in (c) of FIG. 2.

The zeta potential may be measured in a dynamic light scattering method, and when measured by respectively dispersing about 10 mg of the general silica or the silica coated with a compound including an ammonium group in about 5 ml of water, the general silica not coated with a compound including an ammonium group has a zeta potential of about −30 mV, while the silica coated with a compound including an ammonium group has a zeta potential of about +28 mV, and accordingly, these two silicas show a remarkable dispersion difference depending on coating with a compound including an ammonium group as shown in an examination result of FIG. 2 with the naked eye.

### Example 1

### Organic/Inorganic Hybrid Membrane of Carboxylated Polysulfone-Silica Coated with Ammonium Group (CPSF/2.5% Aminated SiO₂)

The carboxylated polysulfone (CPSF) having a substitution degree with a carboxyl group of about 0.49 according to Synthesis Example 1 is mechanically agitated and dissolved in N-methylpyrrolidone as an organic solvent

When the carboxylated polysulfone is completely dissolved therein, the silica nanoparticles coated with a compound including an ammonium group according to Synthesis Example 2 corresponding to about 2.5% of the mass of the carboxylated polysulfone polymer are added thereto, and the mixture is mechanically agitated. The carboxylated polysulfone/amine-coated silica mixed solution is coated to be about 150 μm thick on a glass substrate, and the coated glass substrate is dipped in water as a non-solvent and allowed to stand for greater than or equal to about 10 minutes, forming an organic/inorganic hybrid membrane. When the reaction is complete, the organic/inorganic hybrid membrane is washed with flowing water to completely remove a non-reacted material and the organic solvent.

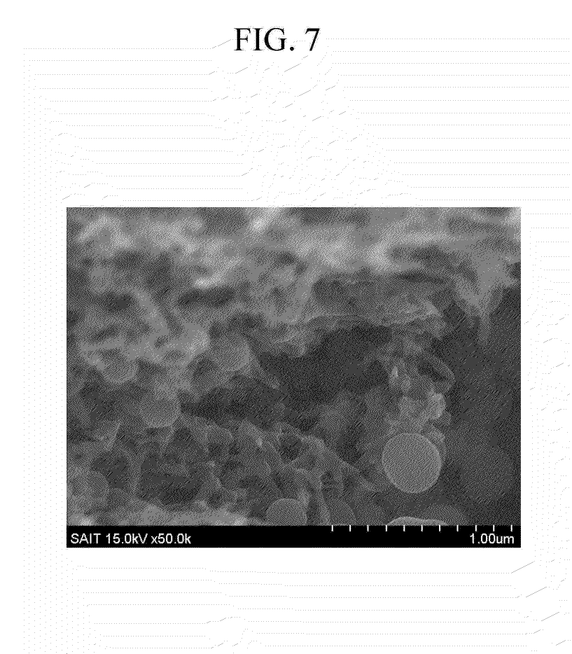

FIG. 7 provides a scanning electron microscopy (SEM) photograph showing the membrane. Referring to FIG. 7, nanometer-sized round silica nanoparticles are well dispersed all over the membrane manufactured by dispersing the silica nanoparticle coated with a compound including an ammonium group into polysulfone having a carboxyl group according to Example 1.

### Comparative Example 1

### Manufacture of Organic/Inorganic Hybrid Membrane of Polysulfone-Silica (PSF/5% SiO₂)

An organic/inorganic hybrid membrane is manufactured according to the same method as Example 1, except for using non-carboxylated polysulfone (Udel 3500, Solvay Chemicals Corp.) as an organic polymer and 5% of hydrophilic silica nanoparticles not coated with a compound including an ammonium group (silica nanoparticles, Aldrich Co., Ltd.) based on the mass of the polymer. In other words, the polysulfone (CPSF) is dissolved in 87 g of DMF (dimethylformamide) as an organic solvent through mechanical agitation, and when the polysulfone is completely dissolved, the silica nanoparticle solution corresponding to about 5% of the mass of the polysulfone mass is added thereto and mechanically agitated therewith. The polysulfone-silica mixed solution is cast to be about 150 μm thick on a glass substrate, and the coated substrate is dipped in water as a non-solvent and allowed to stand for greater than or equal to about 10 minutes, forming an organic/inorganic hybrid membrane. When the reaction is complete, the organic/inorganic hybrid membrane is washed with flowing water to remove a non-reacted material and the organic solvent.

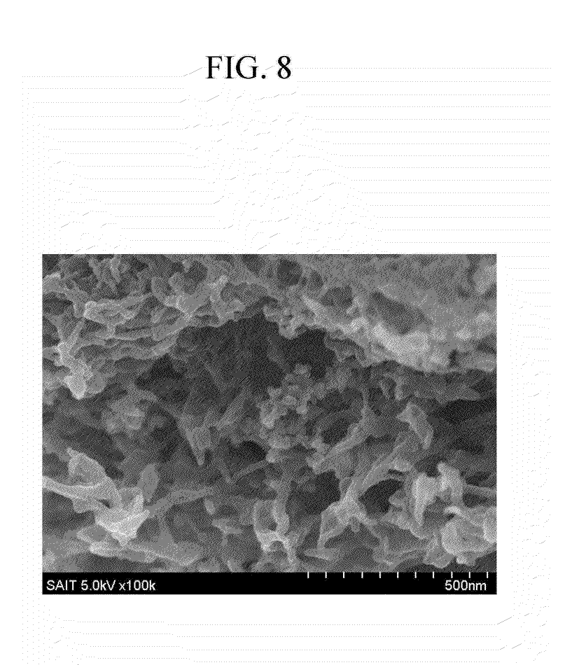

FIG. 8 provides a SEM photograph showing the membrane. Referring to FIG. 8, the nano-sized silica particles shown in FIG. 7 are not found, and silica nanoparticles are aggregated into a size of about 100 nm. Common hydrophilic silica nanoparticles not coated with a compound including an ammonium group are not well dispersed in an organic polymer not including an anionic functional group such as a carboxyl group and the like, but are almost all dispersed in water when a non-solvent induced phase transition is applied thereto.

### Comparative Example 2

### Manufacture of Organic/Inorganic Hybrid Membrane of Polysulfone-Silica Coated with Ammonium Group (PSF/2.5% Aminated-SiO₂)

An organic/inorganic hybrid membrane is manufactured according to the same method as Example 1, except for using non-carboxylated but common polysulfone (Udel 3500, Solvay Chemicals Co.) as an organic polymer and the silica coated with a compound including an ammonium group according to Synthesis Example 2 in an amount of 2.5% based on the entire mass of the polymer. In other words, 13 g of the polysulfone (PSF) is dissolved in 87 g of DMF (dimethylformamide) as an organic solvent through mechanical agitation, and when the polysulfone is all dissolved, the silica coated with a compound including an ammonium group according to Synthesis Example 2 corresponding to about 2.5% of the entire mass of the polysulfone polymer is added thereto and mechanically agitated therewith. The mixed solution of polysulfone-silica coated with a compound including an ammonium group is cast to be about 150 μm thick on a glass substrate, and the coated substrate is dipped in water as a non-solvent and allowed to stand for greater and or equal to about 10 minutes, forming an organic/inorganic hybrid membrane. When the reaction is complete, the organic/inorganic hybrid membrane is washed with flowing water to completely remove a non-reacted material and the organic solvent.

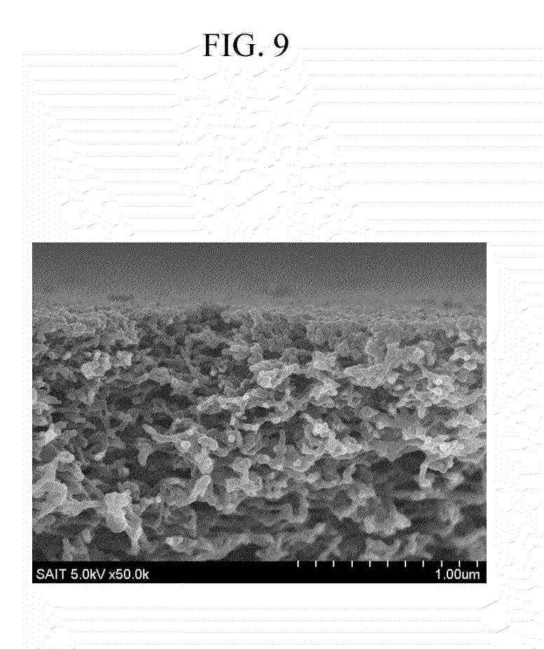

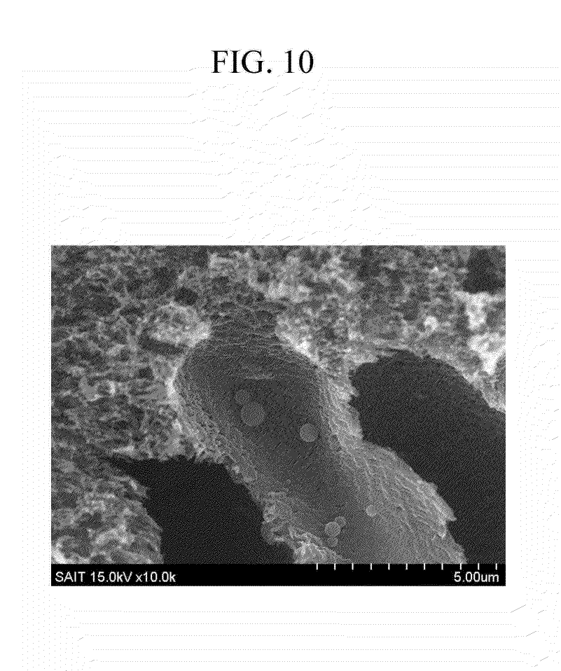

FIG. 9 provides a SEM photograph showing the membrane. FIG. 10 shows several round silica nanoparticles in some regions as a partly enlarged photograph of a part of FIG. 9. Even though silica is coated with a positively-charged material on the surface, the silica is not well dispersed into the organic polymer solution, and thus silica nanoparticles coated with a compound including an ammonium group are not sufficiently dispersed into the organic polymer when the silica is introduced into an organic polymer solution having an anionic functional group. In addition, when a non-solvent induced phase-separation method is applied thereto, the silica nanoparticles have no electrostatic attractive force and the like with the polymer and thus are not maintained inside the organic polymer but are almost all dispersed to the water.

### Example 2

### Manufacture of Separation Membrane Including Organic/Inorganic Hybrid Membrane and Separation Layer

Forward osmosis performance of the organic/inorganic hybrid membranes according to Example 1 and Comparative Example 2 is measured by introducing a polyamide separation layer on the surface of each organic/inorganic hybrid membrane through interface polymerization. Specifically, each organic/inorganic hybrid membrane as a support layer is dipped in an m-methylene diamine (MPD) aqueous solution, so that the m-methylene diamine solution may uniformly permeate into each organic/inorganic hybrid membrane. After removing the methylene diamine solution excessively present on the surface of the membrane with a roller, interface polymerization is induced for one minute by contacting an organic solvent in which trimesoyl chloride (TMC) is dissolved to each membrane. After chemically treating the membrane to remove remaining amine and chloride and washing it with flowing water for greater than or equal to about 30 minutes to remove a non-reacted material and a byproduct, the obtained separation membrane including an organic/inorganic hybrid support layer and a polyamide active layer is blocked from light and refrigerated.

On the other hand, a separation membrane for Control Group 1 manufactured by forming a support layer formed of only polysulfone including no inorganic nanoparticles and a polyamide separation layer thereon according to the same method as above, and another separation membrane for Control Group 2 manufactured by forming a support layer formed of polysulfone including no inorganic nanoparticles but having a carboxyl group and a polyamide separation layer thereon, are refrigerated the same as above.

The support layer formed of only polysulfone in the separation membrane of Control Group 1 is manufactured in the same method as Example 2, except for using polysulfone itself as a raw material instead of introducing a carboxyl group into the polysulfone and adding no inorganic nanoparticles such as silica and the like thereto. In addition, the separation membrane of Control Group 2 may be manufactured in the same method as Example 2, except for using polysulfone having a carboxyl group according to Synthesis Example 1 as an organic polymer and including no inorganic nanoparticles such as silica and the like.

### Experimental Example

### Water Flux and Salt Rejection of Separation Membrane

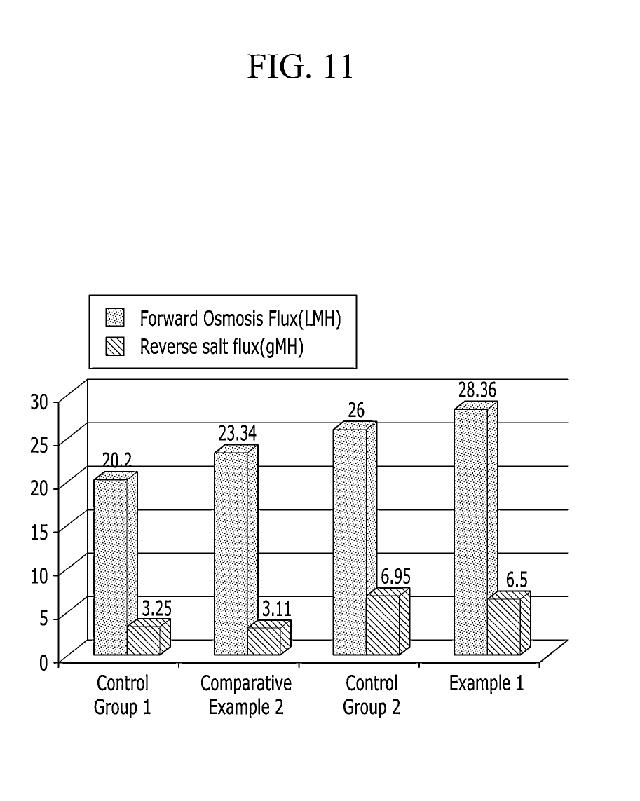

Forward osmosis performance of the separation membranes is evaluated by measuring their forward osmosis flow rate and salt rejection rate with a co-current cross-flow forward osmosis apparatus shown in FIG. 12. A unit cell has a size of 26 mm×77 mm×3 mm (depth). The cell is operated by using each feed solution and draw solution in an amount of 2 L at a cross-flow velocity of 0.5 L/min (25° C.). Deionized water is used for the feed solution, and a 1 M NaCl aqueous solution is used for the draw solution. Herein, the increased mass of the draw solution is converted into the amount of permeated water. In addition, the amount of NaCl going over to the feed solution is measured by using an ion conductivity meter. As shown in FIG. 11, the separation membrane including the organic/inorganic hybrid membrane of Example 1 as a support layer shows the highest water flux and almost equal salt rejection to the separation membrane of Control Group 2 using a support layer not including inorganic nanoparticles but including carboxylated polysulfone. Since salt rejection and water flux are traded off with each other, the salt rejection may decrease when the water flux increases. However, the separation membrane including the organic/inorganic hybrid membrane according to Example 1 as a support layer may maintain high water flux without decreasing salt rejection, and thus shows that the organic/inorganic hybrid membrane of the present disclosure becomes increasingly hydrophilic.

On the other hand, the separation membrane of Control Group 1 using an organic/inorganic hybrid membrane not including inorganic nanoparticles and not introducing an anionic functional group into polysulfone shows the lowest water flux and the lowest salt rejection. On the contrary, the separation membrane of Control Group 2 including no inorganic nanoparticle but introducing an anionic functional group to an organic polymer shows increased water flux and much increased salt rejection compared with the separation membranes of Control Group 1 and Comparative Example 2. In other words, the introduction of a hydrophilic functional group such as an anionic functional group as well as inorganic nanoparticles into an organic polymer has a large influence on increasing hydrophilicity of a separation membrane.

As illustrated so far, an organic/inorganic hybrid membrane according to one example embodiment of the present disclosure may maximize the amount of inorganic nanoparticles in a polymer and thus increase mechanical strength and hydrophilicity of a membrane, and resultantly improve forward osmosis water flux.

Furthermore, since the insoluble nanoparticles are chemically combined with the organic polymer, toxicity due to discharged nanoparticles may be decreased in a long term process of manufacturing a membrane. In addition, an organic/inorganic hybrid may be formed through a mixing process in one step.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. An organic/inorganic hybrid membrane comprising:
a plurality of inorganic nanoparticles dispersed in an organic polymer matrix, the plurality of inorganic nanoparticles having a surface that is coated with a silane compound, the silane compound including a cationic functional group selected from an ammonium group (—NH₃⁺), a phosphonium group (—PR₄⁺), or a sulfonium group (—SR₃⁺), the organic polymer matrix including an anionic functional group, the organic/inorganic hybrid membrane having a configuration resulting from a non-solvent induced phase-separation method.

2. The organic/inorganic hybrid membrane of claim 1, wherein the silane compound is represented by the following Chemical Formula 1: 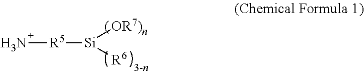
in Chemical Formula 1,
R⁵ is a C1 to C20 alkylene, a C2 to C20 alkenylene, a C2 to C20 alkynylene, a C3 to C20 cycloalkylene, or a C6 to C18 arylene,
R⁶ and R⁷ are the same or different, and are independently hydrogen, a C1 to C20 alkyl, a C2 to C20 alkenyl, a C2 to C20 alkynyl, a C3 to C20 cycloalkyl, or a C6 to C18 aryl, and
n is an integer ranging from 1 to 3.

3. The organic/inorganic hybrid membrane of claim 1, wherein the plurality of inorganic nanoparticles comprise oxide nanoparticles or hydroxide nanoparticles of Ti, Al, Zr, Si, Sn, B, or Ce.

4. The organic/inorganic hybrid membrane of claim 1, wherein the organic polymer matrix comprises an aryl backbone polymer or a cellulose-based polymer, the aryl backbone polymer selected from polysulfone, polyethersulfone, polyphenylsulfone, polyetherethersulfone, polyetherketone, polyetheretherketone, polyphenylene ether, polydiphenylphenylene ether, and polyphenylene sulfide, the cellulose-based polymer selected from cellulose acetate, cellulose diacetate, and cellulose triacetate.

5. The organic/inorganic hybrid membrane of claim 1, wherein the anionic functional group is selected from a carboxyl group (—COOH), a sulfonic acid group (—SO₃H), a phosphinic group (—PO₃H₂), a phosphonic group (—HPO₃H), and a nitrous acid group (—NO₂H).

6. The organic/inorganic hybrid membrane of claim 1, wherein the plurality of inorganic nanoparticles are silica (SiO₂), and the silane compound is 3-ammoniumpropyl trimethoxysilane (APS).

7. The organic/inorganic hybrid membrane of claim 1, wherein the organic polymer matrix comprises polysulfone or polyethersulfone, the polysulfone or polyethersulfone being substituted with a carboxyl group.

8. The organic/inorganic hybrid membrane of claim 1, wherein the plurality of inorganic nanoparticles are bonded to the organic polymer matrix by an electrostatic attractive force between the cationic functional group and the anionic functional group.

9. The organic/inorganic hybrid membrane of claim 1, wherein an average particle size of the plurality of inorganic nanoparticles is less than or equal to about 100 nm.

10. The organic/inorganic hybrid membrane of claim 1, wherein an average particle size of the plurality of inorganic nanoparticles is about 20 nm to about 30 nm.

11. The organic/inorganic hybrid membrane of claim 1, wherein a content of the plurality of inorganic nanoparticles is about 1% to about 30% based on a total weight of the organic polymer matrix.

12. The organic/inorganic hybrid membrane of claim 1, wherein a content of the plurality of inorganic nanoparticles is about 2% to about 20% based on a total weight of the organic polymer matrix.

13. A separation membrane for water treatment comprising the organic/inorganic hybrid membrane of claim 1.

14. The separation membrane for water treatment of claim 13, further comprising:
a separation layer on the organic/inorganic hybrid membrane, the separation layer being water permeable but non-permeable for a subject material to be separated.

15. The separation membrane for water treatment of claim 14, wherein the separation layer includes a polymer matrix selected from polyamide, polyethylene, polyester, polyisobutylene, polytetrafluoroethylene, polypropylene, polyacrylonitrile, polysulfone, polyethersulfone, polycarbonate, polyethylene terephthalate, polyimide, polyvinylene fluoride, polyvinylchloride, cellulose acetate, cellulose diacetate, and cellulose triacetate.

16. A water treatment device comprising the separation membrane of claim 13.

17. A method of manufacturing an organic/inorganic hybrid membrane, comprising:
combining a plurality of inorganic nanoparticles with a silane compound having a cationic functional group selected from an ammonium group (—NH₃⁺), a phosphonium group (—PR₄⁺), and a sulfonium group (—SR₃⁺) to obtain surface-coated inorganic nanoparticles;
introducing the surface-coated inorganic nanoparticles into a solution of an organic polymer material including an anionic functional group to prepare a mixed solution; and
applying a non-solvent induced phase-separation method after casting the mixed solution on a substrate to obtain an organic polymer matrix with the plurality of inorganic nanoparticles dispersed therein.

18. The method of claim 17, wherein the combining includes coating a plurality of silica nanoparticles with a compound of the following Chemical Formula 1: 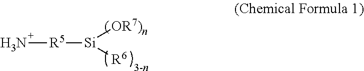
in Chemical Formula 1,
R⁵ is a C1 to C20 alkylene, a C2 to C20 alkenylene, a C2 to C20 alkynylene, a C3 to C20 cycloalkylene, or a C6 to C18 arylene,
R⁶ and R⁷ are the same or different, and are independently hydrogen, a C1 to C20 alkyl, a C2 to C20 alkenyl, a C2 to C20 alkynyl, a C3 to C20 cycloalkyl, or a C6 to C18 aryl, and
n is an integer ranging from 1 to 3.

19. The method of claim 17, wherein the introducing includes immersing the surface-coated inorganic nanoparticles into the solution of the organic polymer material, the organic polymer material being an aryl backbone polymer or a cellulose-based polymer, the aryl backbone polymer selected from polysulfone, polyethersulfone, polyphenylsulfone, polyetherethersulfone, polyetherketone, polyetheretherketone, polyphenylene ether, polydiphenylphenylene ether, and polyphenylene sulfide, the cellulose-based polymer selected from cellulose acetate, cellulose diacetate, and cellulose triacetate, the anionic functional group selected from a carboxyl group (—COOH), a sulfonic acid group (—SO₃H), a phosphinic group (—PO₃H₂), a phosphonic group (—HPO₃H), and a nitrous acid group (—NO₂H).

20. A method of manufacturing a separation membrane for water treatment, comprising:
combining a plurality of inorganic nanoparticles with a silane compound having a cationic functional group selected from an ammonium group (—NH₃⁺), a phosphonium group (—PR₄⁺), and a sulfonium group (—SR₃⁺) to obtain surface-coated inorganic nanoparticles;
introducing the surface-coated inorganic nanoparticles into a solution of an organic polymer material including an anionic functional group to prepare a mixed solution;
applying a non-solvent induced phase-separation method after casting the mixed solution on a substrate to manufacture an organic/inorganic hybrid membrane, the organic/inorganic hybrid membrane including the plurality of inorganic nanoparticles dispersed in an organic polymer matrix; and
polymerizing a separation layer through interface polymerization on the organic/inorganic hybrid membrane.
